(19) United States
(12) Patent Application Publication
(10) Pub. No.: US 2023/0086828 A1
(43) Pub. Date: Mar. 23, 2023

(54) FEATURE LOCATION DETERMINATIONS USING DIGITAL ELLIPSOIDS

(71) Applicant: Hewlett-Packard Development Company, L.P., Spring, TX (US)

(72) Inventors: Mary Gray BAKER, Palo Alto, CA (US); William J. ALLEN, Corvallis, OR (US); John J. BRIDEN, Palo Alto, CA (US); Matthew A. SHEPHERD, Vancouver, WA (US)

(73) Assignee: Hewlett-Packard Development Company, L.P., Spring, TX (US)

(21) Appl. No.: 17/909,203

(22) PCT Filed: Mar. 31, 2020
(86) PCT No.: PCT/US2020/026016

§ 371 Date: Sep. 2, 2022

(51) Int. Cl. G06F 30/10; G06F 30/20

(52) U.S. Cl. CPC G06F 30/10; G06F 30/20; G06F 2113/22

(57) ABSTRACT

According to examples, an apparatus may include a processor that may access a digital model of an item to be fabricated to have a plurality of features, in which the digital model may include a surface. The processor may pack a plurality of digital ellipsoids to intersect the surface of the digital model of the item, in which the plurality of digital ellipsoids are arranged with respect to each other based on a curvature of the surface. The processor may also determine locations on the surface at which the plurality of digital ellipsoids intersect the surface and may set the determined locations as points on the surface at which the plurality of features are to be formed.

### BACKGROUND

Computer aided design (CAD) tools may determine the locations at which features such as holes or protrusions are to be formed in or on an item. The CAD tools may take an approach in which the CAD tools may cut seams into an exterior surface of a part. The CAD tools may also take an approach in which a pattern applied to a flat surface may be stretched over a curved or a bent surface.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of an example apparatus that may determine locations at which a plurality of features are to be formed on an item;

FIG. 2 depicts an isometric view of an example item having features, in which the apparatus depicted in FIG. 1 may determine the locations of the features;

FIGS. 3A and 3B, respectively, depict example placements of digital ellipsoids that intersect surfaces of digital models of items;

FIG. 4 shows an isometric view of the item depicted in FIG. 2 with digital ellipsoids being placed to intersect a surface of a digital model of the item;

FIG. 5 shows a cross-sectional side view of an example pulp molding die that may include the example item, e.g., a screen device, and a main body;

FIG. 6 depicts a flow diagram of an example method for determining locations on a surface of an item at which features are to be formed such that the features may be evenly spaced with respect to each other; and

FIG. 7 shows a block diagram of a computer-readable medium that may have stored thereon computer-readable instructions for determining locations on a curved surface corresponding to points of digital ellipsoids placed to intersect the curved surface.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Determination of the locations of features through the first approach discussed above may result in distorted patterns of the features due to, for instance, seams being noticeable and the patterns on the multiple pieces not being spaced evenly with respect to each other. Additionally, determination of the locations of the features through the approach in which CAD tools may take a pattern applied to a flat surface and may stretch the pattern over a curved or a bent surface result in distortions of a pattern around curved areas and may result in the features not being able to perform their intended function.

Disclosed herein are apparatuses that may determine locations on a digital model of an item at which features, such as holes, protrusions, or other types of features, may be placed such that the item may be fabricated to have those features at the determined locations. Particularly, a processor may pack a plurality of digital ellipsoids to intersect a surface of the digital model of the item, in which the digital ellipsoids may have a certain spacing with respect to each other and certain diameters. As discussed in greater detail herein, the processor may select the diameters and may pack the digital ellipsoids with respect to each other based on a curvature of the surface. The processor may determine the locations on the surface of the digital model at which the digital ellipsoids intersect the surface and may set the determined locations as points on the surface at which the features are to be formed. The processor may further remove the digital ellipsoids and may add digital representations of the features at the determined locations in the digital model such that, for instance, the digital model may be employed in fabricating the item with the features positioned at the determined locations.

According to examples, the items may be screen devices having pores or apertures, in which the screen devices may be employed to filter material elements from a fluid. By way of particular example, the items may be screen devices that may be employed to filter material elements, e.g., fibers, from a slurry composed of the fluid and material elements to form a part from the material elements. In any of these examples, the processor may determine the locations at which the pores are to be formed in the screen devices such that, for instance, the pores are spaced evenly with respect to each other (or at other intended spacings) and/or at appropriate density levels to achieve intended flow rates through the pores. In addition, the pores may have any suitable geometric shape such as circular, spherical, hexagonal, octagonal, and/or the like, and some of the features may have different shapes with respect to each other.

Through implementation of the features of the present disclosure, a processor may identify locations on the surface of the item such that the features may be formed in or on the item at evenly spaced positions, or other intended distributions, with respect to each other regardless of the shape, e.g., curvature, of the item. As discussed herein, the processor may use digital ellipsoids having the same diameters with respect to each other or having multiple diameters with respect to each other to determine the locations at which the features may be formed. The locations on the surface may be spaced according to a function, such as a linear function, a step-wise function, an exponential function, or the like, in which the spacing may expand or contract along a portion of a length or a width of the surface based, for instance, on the curvature of the surface.

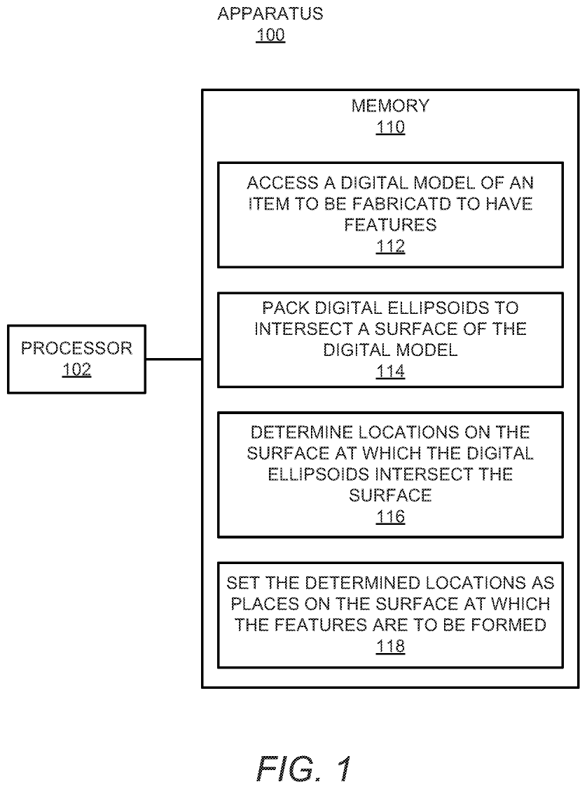

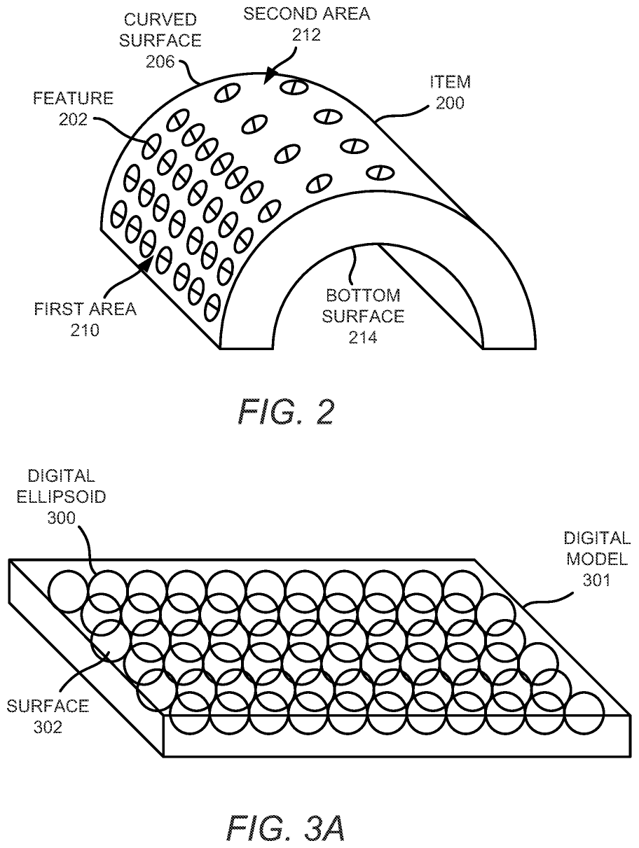

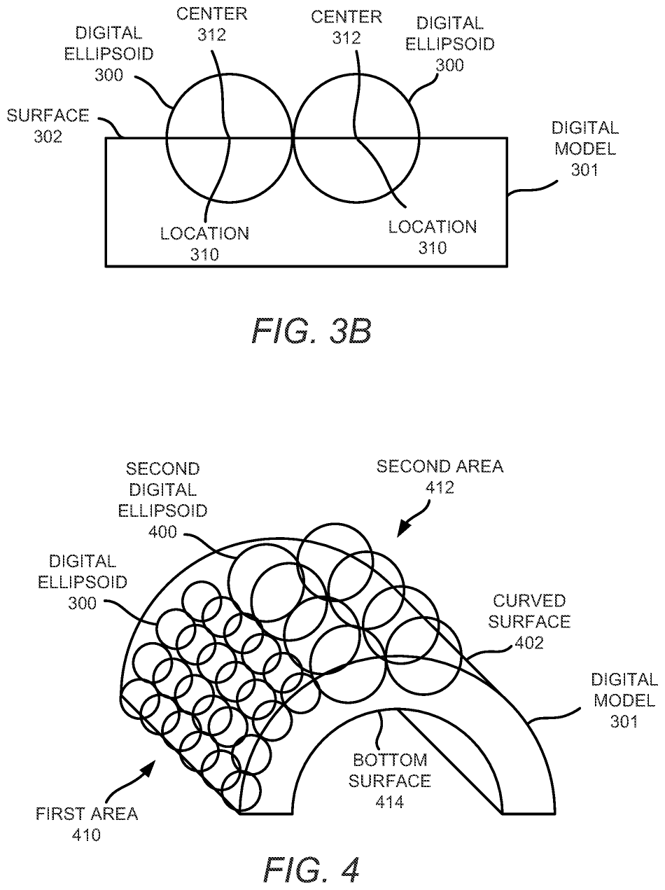

Reference is first made to FIGS. 1, 2, 3A, and 33. FIG. 1 shows a block diagram of an example apparatus 100 that may determine locations at which a plurality of features are to be formed on an item. FIG. 2 shows an isometric view of an example item 200 having features 202, in which the apparatus 100 depicted in FIG. 1 may determine the locations of the features 202. FIGS. 3A and 3B, respectively, depict example placements of digital ellipsoids 300, 400 that intersect surfaces 302 of digital models 301 of items 200. It should be understood that the example apparatus 100 depicted in FIG. 1, the example item 200 depicted in FIG. 2, and/or the example placements of digital ellipsoids 300, 400 depicted in FIGS. 3A and 3B may include additional attributes and that some of the attributes described herein may be removed and/or modified without departing from the scopes of the apparatus 100, the example items 200, and/or the example digital ellipsoid 300, 400 placements.

The apparatus 100 may be a computing system such as a server, a laptop computer, a tablet computer, a desktop computer, or the like. As shown, the apparatus 100 may include a processor 102, which may be a semiconductor- based microprocessor, a central processing unit (CPU), an application specific integrated circuit (ASIC), a field-programmable gate array (FPGA), and/or other suitable hardware device. The apparatus 100 may also include a memory 110 that may have stored thereon machine-readable instructions (which may also be termed computer-readable instructions) that the processor 102 may execute. The memory 110 may be an electronic, magnetic, optical, or other physical storage device that contains or stores executable instructions. The memory 110 may be, for example, Random Access memory (RAM), an Electrically Erasable Programmable Read-Only Memory (EEPROM), a storage device, an optical disc, and the like. The memory 110, which may also be referred to as a computer readable storage medium, may be a non-transitory machine-readable storage medium, where the term “non-transitory” does not encompass transitory propagating signals.

Although the apparatus 100 is depicted as having a single processor 102, it should be understood that the apparatus 100 may include additional processors and/or cores without departing from a scope of the apparatus 100. In this regard, references to a single processor 102 as well as to a single memory 110 may be understood to additionally or alternatively pertain to multiple processors 102 and multiple memories 110. In addition, or alternatively, the processor 102 and the memory 110 may be integrated into a single component, e.g., an integrated circuit on which both the processor 102 and the memory 110 may be provided.

As shown in FIG. 1, the memory 110 may have stored thereon machine-readable instructions 112-118 that the processor 102 may execute. Although the instructions 112-118 are described herein as being stored on the memory 110 and may thus include a set of machine-readable instructions, the apparatus 100 may include hardware logic blocks that may perform functions similar to the instructions 112-118. For instance, the processor 102 may include hardware components that may execute the instructions 112-118. In other examples, the apparatus 100 may include a combination of instructions and hardware logic blocks to implement or execute functions corresponding to the instructions 112-118. In any of these examples, the processor 102 may implement the hardware logic blocks and/or execute the instructions 112-118. As discussed herein, the apparatus 100 may also include additional instructions and/or hardware logic blocks such that the processor 102 may execute operations in addition to or in place of those discussed above with respect to FIG. 1.

The processor 102 may execute the instructions 112 to access a digital model 301 of an item 200 to be fabricated to have a plurality of features 202. Examples of digital models 301 of the item 200 are depicted in FIGS. 3A-4 for purposes of illustration. The item 200 depicted in FIG. 2 is shown as having a curved surface 206 and the features 202 on the curved surface 206 are depicted as pores that may extend through the item 200. The example digital model 301 is depicted in FIG. 3A as having a flat surface and may be in a state prior to the addition of features on the digital model 301 of an item. It should be understood that the items 200 and the digital models 301 discussed in the present disclosure may include other shapes and/or that the features 202 may instead be protrusions and/or have other shapes without departing from scopes of the items 200.

The digital model 301 of an item, e.g., the item 200 depicted in FIG. 2, may be a three-dimensional (3D) computer model of the item, such as a computer aided design (CAD) file, or other digital representation of the item. In addition, the processor 102 may access the digital model 301 of the item from a data store (not shown) or some other suitable source. In some examples, the digital model 301 of the item may be generated using a CAD program. In addition, the density at which the features 202 are to be formed in or on the item 200 may be defined in the digital model 301 of the item 200. Moreover, the CAD program may be used to define the physical geometry of the digital model 301 and a separate program may be used to add digital representations of the features 202 to a surface of the digital model 301 of the item. That is, the separate program may employ a process involving the packing or placing of digital ellipsoids on the surface of the digital model 301 to determine the locations at which the digital representations of the features 202 are to be positioned on the surface of the digital model 301.

The processor 102 may execute the instructions 114 to pack a plurality of digital ellipsoids 300 to intersect the surface 302 of the digital model 301 of the item 200. The digital ellipsoids 300 may be digital representations of ellipsoids that may be arranged with respect to the digital model 301 of the item and may have place sections that are circular or elliptical. Thus, for instance, the processor 102 may arrange the digital ellipsoids 300 to intersect the surface 302 in a modeling program. According to examples, the processor 102 may pack the digital ellipsoids 300 such that most or all of the digital ellipsoids 300 do not overlap with any other ones of the digital ellipsoids 300.

As shown in FIGS. 3A and 3B, each of the digital ellipsoids 300 may be arranged to intersect the surface 302 and may be arranged at a determined spacing with respect to each other. Thus, for instance, the processor 102 may comply with constraints when placing the digital ellipsoids 300 to intersect the surface 302 of the digital model 301. The first constraint may be that the digital ellipsoids 300 intersect the surface 302 at only points on the surface of the digital ellipsoids 300. For instance, the digital ellipsoids 300 may cross the plane of the surface 302 at the respective centers of the digital ellipsoids 300.

A second constraint may be that the centers of the digital ellipsoids 300 may be arranged, e.g., spaced from each other, based on a curvature of a surface 302 on which the digital ellipsoids 300 may intersect. For instance, the centers of the digital ellipsoids 300 may be relatively closer to each other when the surface 302 is relatively flat and may be relatively farther apart from each other when the surface 302 is curved. Thus, for instance, the distances between the digital ellipsoids 300 may be based upon the curvature of the surface 302. As discussed herein, a curved surface 302 may also denote a flat surface in which the curvature of the surface is zero.

The processor 102 may generate the digital ellipsoids 300 to have certain diameters, in which the certain diameters of the digital ellipsoids 300 may correspond to a property of the features 202. The property of the features 202 may be, for instance, a density at which the features 202 are to be formed in the item 200. That is, for instance, the processor 102 may determine the diameters of the digital ellipsoids 300 that may result in the features 202 being formed according to the intended density, e.g., a number of features 202 per area unit of the surface 302. A user and/or a CAD program may define the intended density according to, for instance, intended properties of the item 200. The property of the features 202 may additionally or alternatively be shapes of the features, sizes of the features, and/or the like. In these examples, the processor 102 may determine the diameters of the digital ellipsoids 300 that may result in the features 202 being positioned with respect to each other while compensating for the shapes and/or sizes of the features 202.

In a first example, the property of the features 202 may be defined based on an intended aesthetic afforded by the spacing of the features 202. In another example, the property of the features 202 may be defined based on predicted flow properties of a fluid, e.g., a liquid or a gas, over and/or through the item 200. For instance, fluid dynamics modeling may be performed on the digital model 301 of the item 200 to determine a density of the features 202 that is predicted to result in the flow properties being optimized. For instance, fluid dynamics modeling may be performed on the digital model 301 to determine properties of the features 202, e.g., dimensions, densities, etc., that may maximize flow of a fluid while minimizing flow of material elements through the features 202. In any of these examples, some of the features 202 may have a different property with respect to others of the features 202. Thus, for instance, different sized digital ellipsoids 300 may be used to determine the locations of the features 202 depending upon the respective properties of the features 202.

In some examples, the item 200 may be a screen device having features 202, e.g., pores, in which the screen device may be employed to filter fluid from a slurry composed of the fluid and material elements to form a part from the material elements. In some examples, the fluid may be water or another type of suitable fluid in which pulp material, e.g., paper, wood, fiber crops, bamboo, or the like, may be mixed into a slurry. The material elements may be, for instance, fibers of the pulp material. In these examples, the sizes of the features 202, e.g., pores, may be defined by the sizes of the fibers in the slurry. For instance, the features 202 may be sized to prevent or limit the flow of the fibers into the features 202.

In addition to the pores 202, the screen device 200 may include structures such that, for instance, the pores 202 may be formed between the structures. According to examples, the structures may be formed by fusing build material particles together, which may be fused together during a 3D fabrication process by a 3D fabrication system. In these examples, the build material particles may be any suitable type of material that may be employed in 3D fabrication processes, such as, a metal, a plastic, a nylon, a ceramic, an alloy, and/or the like. In some examples, the screen device may be formed to a have relatively thin height and may be relatively pliable. In other examples, the structures may be formed through other fabrication techniques such as selective laser ablation, selective laser melting, stereolithography, fused deposition modeling, and/or the like.

According to examples, the digital model 301 of the item 200 may include information corresponding to the surface 302. In these examples, the processor 102 may access the properties of the features 202 to be formed on the surface 302 from the information corresponding to the surface 302. In addition, the information corresponding to the surface 302 may include a color value and/or a texture value assigned to the surface 302, in which different color values and/or texture values may correspond to different properties. In some examples, the digital model 301 may include the information in an existing channel corresponding to the digital model 301. Thus, for instance, the processor 102 may access a property of the features 202 to be formed on the surface 302 from the information corresponding to the surface 302 as identified in the color channel of the digital model 301. By way of example, the information may identify a particular color value for the surface 302 in the color channel and the processor 102 may determine a correlation between the property and the color value to determine the property density at which the features 202 are to be formed on the surface 302.

In addition, the processor 102 may determine a spacing of the digital ellipsoids 300 that corresponds to the properties of the features 202. In one regard, by including the properties of the features 202 in an existing channel of the digital model 301, a separate file for the properties may not be employed.

The processor 102 may execute the instructions 116 to determine locations 310 on the surface 302 at which the digital ellipsoids 300 may intersect the surface 302. An enlarged view of two of the digital ellipsoids 300 intersecting the surface 302 of the digital model 301 of the item 200 is depicted in FIG. 3B. As shown in FIG. 3B, the digital ellipsoids 300 may intersect the surface 302 at respective locations 310. Particularly, the centers 312 of the digital ellipsoids 300 may intersect the locations 310. In other examples, however, points on the peripheries of the digital ellipsoids 300 may contact the locations 310 on the surface 302.

In some examples, the digital ellipsoids 300 may contact some or all of their neighboring digital ellipsoids 300. In addition, some of the digital ellipsoids 300 may overlap a neighboring digital ellipsoid 300 or gaps may exist between some of the neighboring digital ellipsoids 300. According to examples, the processor 102 may arrange the digital ellipsoids 300 to minimize overlapping and gaps among and between the digital ellipsoids 300. For instance, the processor 102 may assign a cost function to the overlapping and gaps and may reduce or minimize costs. The processor 102 may also vary the diameters of some of the digital ellipsoids 300 to minimize the overlapping and gaps while meeting other criteria, such as maintaining certain minimum distances between the digital ellipsoids 300.

The processor 102 may execute the instructions 118 to set the determined locations 310 as points on the surface 302 at which the features 202 are to be formed. In examples in which the diameters of the digital ellipsoids 300 may be the same and the digital ellipsoids 300 have the same orientations with respect to each other, the determined locations 310 may be evenly spaced with respect to each other. However, in examples in which the diameters may differ and/or some of the digital ellipsoids 300 have different orientations with respect to each other (in instances in which the digital ellipsoids 300 have oval cross- sections), the determined locations 310 may be evenly spaced or may be otherwise distributed with respect to each other. In a particular example in which the features 202 are to be evenly spaced with respect to each other in all directions, the digital ellipsoids 300 may have spherical shapes.

In any regard, the processor 102 may modify the digital model 301 to include the determined locations 310 as the locations at which the features 202 are to be formed. In addition, the processor 102 may remove the digital ellipsoids 300 and may add digital representations of the features 202 at the set points on and/or through the surface 302 at which the features 202 are to be formed such as by modifying the digital model 301 to include the digital representations of the features 202. As a result, a 3D fabrication system may employ the digital model to fabricate the item 200, in which the fabricated item 200 may include the features 202 positioned at the locations 310 determined on the digital model 301.

According to examples, and as shown in FIG. 4, the digital model 301 of the item 200 may identify a first area 410 of a curved surface 402 that corresponds to a first area 210 of a curved surface 206 of the item 200. The first area 210 of the curved surface 206 of the item 200 may be fabricated with the plurality of features 202 having a first property, e.g., to be arranged at a first density level, to have a first size, etc., and a second area 212 of the curved surface 206 of the item 200 with the plurality of features 202 having a second property, e.g., to be arranged at a second density level, to have a second size, etc. As shown in FIG. 2, the first area 210 may include features 202 that may be at a higher density level than features 202 in the second area 212 of the curved surface 206. In some examples, the features 202 may be arranged at a lower density level for fluid flow control purposes, for structural purposes, for aesthetic purposes, and/or the like. For instance, as shown in FIG. 2, the features 202 in the second area 212 may be arranged at a higher density level to prevent bottom portions of the features 202, e.g., on or near a bottom surface 214 of the item 200, from overlapping each other, which may result in reduced structural integrity of the item 200 as may occur when the item 200 includes a curved surface 206.

In these examples, the processor 102 may pack the plurality of digital ellipsoids 300 in the first area 410 of the curved surface 402 of the digital model 301 of the item 200. As shown in FIG. 4, the digital ellipsoids 300 may be placed to intersect the curved surface 402 following the curvature of the digital model 301 at the first area 410. In addition, the processor 102 may pack a second plurality of digital ellipsoids 400 in a second area 412 of the curved surface 402 of the digital model 301. The second digital ellipsoids 400 in the second area 412 may each have a different diameter than the digital ellipsoids 300 in the first area 410 of the curved surface 402. For instance, the second digital ellipsoids 400 in the second area 412 may have relatively larger diameters than the digital ellipsoids 300 in the first area 410. The processor 102 may comply with constraints regarding contact of the digital ellipsoids 300 and 400 with the curved surface 402 and their respective spacings as discussed above in packing the digital ellipsoids 300 and the second digital ellipsoids 400 on the curved surface 402. The processor 102 may determine additional digital ellipsoids having other sizes. In some examples, the processor 102 may determine the other sizes as increasing or decreasing in size according to a function, such as linearly, step- wise, exponentially, or the like.

In other examples, the processor 102, instead of packing the second digital ellipsoids 400 to intersect an upper surface, e.g., the curved surface 402 of the digital model 301, may pack digital ellipsoids 300 to intersect a bottom surface 414 corresponding to the second area 412. By packing the digital ellipsoids 300 to intersect the bottom or inside part of the curved surface 402, the bottom sections of the features 202 corresponding to the locations 310 of the digital ellipsoids 300 may be formed such that the bottom sections do not overlap with each other. In these examples, the digital ellipsoids 300 having the same or similar diameters to the digital ellipsoids 300 in the first area 410 may be placed on the inside part of the curved surface 402.

In any of the examples discussed above, the processor 102 may determine locations 310 of the first area 410 of the curved surface 402 corresponding to centers of the plurality of digital ellipsoids 300. The processor 102 may also determine locations 310 of the second area 412 of the curved surface 402 corresponding to centers 312 of the second plurality of digital ellipsoids 400. The processor 102 may determine the locations 310 in any of the manners discussed above with respect to FIG. 3B. The processor 102 may further set the determined locations 310 of the first area 410 and the second area 412 as points on the curved surface 402 at which the plurality of features 202 are to be formed. In addition, the processor 102 may remove the digital ellipsoids 300, 400 and add digital representations of the features 202 at the set points on the curved surface 402 as discussed herein. Generally speaking, the processor 102 may use the digital ellipsoids 300, 400 to determine the locations of each of a set of features 202 (e.g., pores) that are to be added to a digital model 301 of an item 200. In addition, the digital model 301 may be employed to fabricate the item 200, e.g., through implementation of a 3D fabrication system, in which the item 200 may be a screen that may be used as a filter.

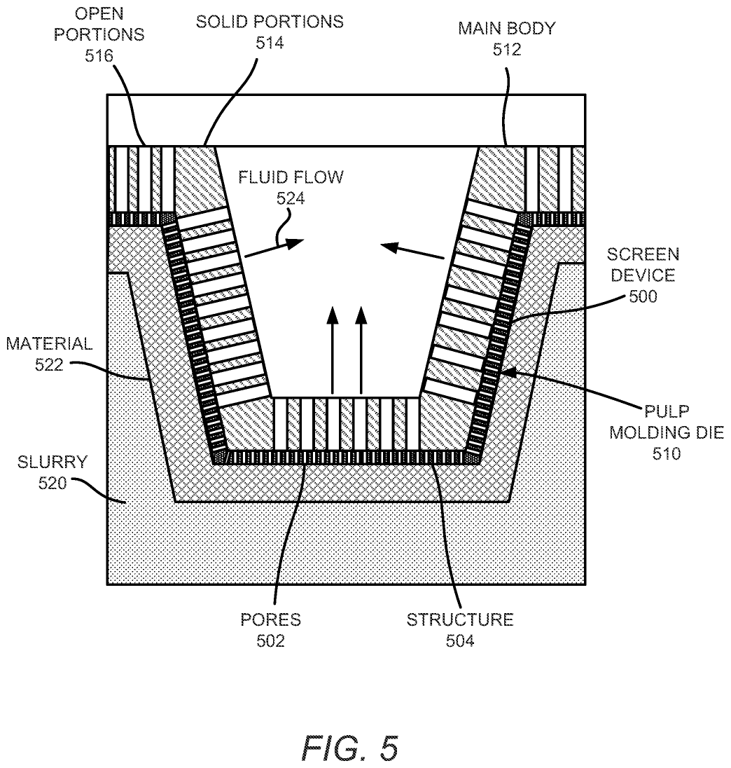

As discussed herein, the item 200 may be a screen device that may filter fluid from a slurry composed of the fluid and material elements to form a part from the filtered material elements. An example of a screen device 500 having pores 502 formed through structures 504 is depicted in FIG. 5. Particularly, FIG. 5 shows a cross-sectional side view of an example pulp molding die 510 that may include the example screen device 500 and a main body 512. As shown, the screen device 500 may overlay the main body 512. The main body 512 may be formed to have a relatively larger thickness than the screen device 500 and may be substantially more rigid than the screen device 500. The main body 512 may thus provide structural support for the screen device 500. The main body 512 may also be formed of solid portions 514 and open portions 516. According to examples, the placements of the open portions 516 may be determined through packing of the digital ellipsoids 300 discussed herein with respect to identifying the locations 310 on the surface 302 of the digital model of the main body 512.

The solid portions 514 may be formed of a substantially rigid material, such as a metal, a plastic, a ceramic, and/or the like. In addition, the open portions 516 may be formed between the solid portions 514 through any suitable fabrication technique. For instance, the open portions 516, which may also be referenced herein as openings, pores, through holes, or the like, may be formed through a 3D fabrication process, drilling, through use of a mold, and/or the like. In any of these examples, the open portions 516 may extend from one side of the main body 512 to an opposite side of the main body 512. In some examples, the main body 512 and the screen device 500 may be formed together during a 3D fabrication process.

According to examples, the open portions 516 may have circular cross-sections that may be relatively larger in diameter than the pores 502. Although in other examples, the open portions 516 may have cross-sections having other shapes. In operation, a vacuum, or reduced pressure, may be applied from a side of the main body 512 opposite the screen device 500 when the pulp molding die 510 is immersed in a pulp or slurry 520 containing a material 522. As fluid in the pulp or slurry 520 flows through the pores 502 in the screen device 500 and the open portions 516 in the main body 512 as denoted by the arrows 524, the material 522 in the pulp or slurry 520 may be accumulated and compressed onto the screen device 500 and may take the shape of the screen device 500. Particularly, the material 522 may form into a part on the screen device 500 as the fluid is drawn from the slurry 520 and the remaining material 522 is eventually dried.

According to examples, the processor 102 may cause a three- dimensional (3D) fabrication system to fabricate the item 200 to have features 202 formed on the item 200 at the determined locations 310. In addition, the processor 102 may cause the 3D fabrication system to fabricate the main body 512 to have open portions 516. The processor 102 may cause any suitable type of 3D fabrication system to fabricate the item 200 and/or the main body 512.

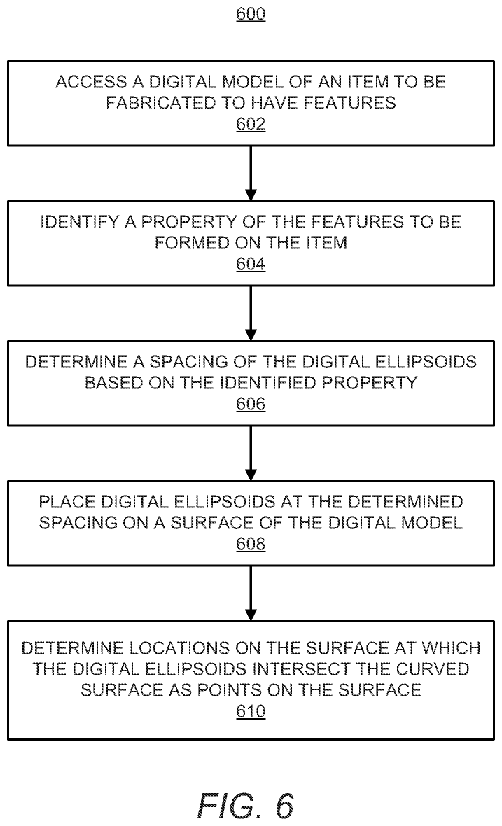

Turning now to FIG. 6, there is shown a flow diagram of an example method 600 for determining locations 310 on a surface 302 of a digital model 301 of an item 200 at which digital representations of features 202 are to be formed such that the features 202 may be evenly spaced with respect to each other. It should be understood that the method 600 depicted in FIG. 6 may include additional operations and that some of the operations described therein may be removed and/or modified without departing from the scope of the method 600. The description of the method 600 is also made with reference to the features depicted in FIGS. 1-5 for purposes of illustration. Particularly, the processor 102 may execute some or all of the operations included in the method 600.

At block 602, the processor 102 may access a digital model 301 of an item 200 to be fabricated to have a plurality of features 202. The processor 102 may access the digital model 301 as discussed herein. At block 604, the processor 102 may identify a property of the plurality of features 202 to be formed on the item 200 as discussed herein. At block 606, the processor 102 may determine a spacing of the plurality of digital ellipsoids 300 to be placed to intersect a surface 302 of the digital model 301 based on the identified property of the plurality of features 202. At block 608, the processor 102 may place the plurality of the digital ellipsoids 300 at the determined spacing on the surface 302 of the digital model 301, in which the plurality of digital ellipsoids 300 are placed to intersect the surface 302. In addition, at block 610, the processor 102 may determine locations 310 on the surface 302 at which the plurality of digital ellipsoids 300 intersect the surface 302 as points on the surface 302 at which the plurality of features 202 are to be formed.

The processor 102 may determine the positions 310 as the centers of the digital ellipsoids 300 or contact positions of the digital ellipsoids 300 and the surface 302. In some examples, the processor 102 may determine features 202 having different properties at different areas of the surface 302 as discussed herein. The processor 102 may also remove the digital ellipsoids 300 and may add digital representations of the features 202 at the determined locations 310 on the surface 302 of the digital model 301. The processor 102 may further cause a 3D fabrication system to fabricate the item 200 with the added features 202 at the determined locations 310.

As discussed herein, the digital model 301 may include information corresponding to the surface 302 of the digital model 301. The processor 102 may identify the property of the plurality of features 202 to be formed on the item 200 from the information corresponding to the surface 302. As also discussed herein, the information corresponding to the surface 302 may include a color value and/or a texture value assigned to the surface 302, in which different color values and/or texture values may correspond to different density levels.

Some or all of the operations set forth in the method 600 may be contained as utilities, programs, or subprograms, in any desired computer accessible medium. In addition, the method 600 may be embodied by computer programs, which may exist in a variety of forms. For example, the method 600 may exist as machine-readable instructions, including source code, object code, executable code or other formats. Any of the above may be embodied on a non- transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

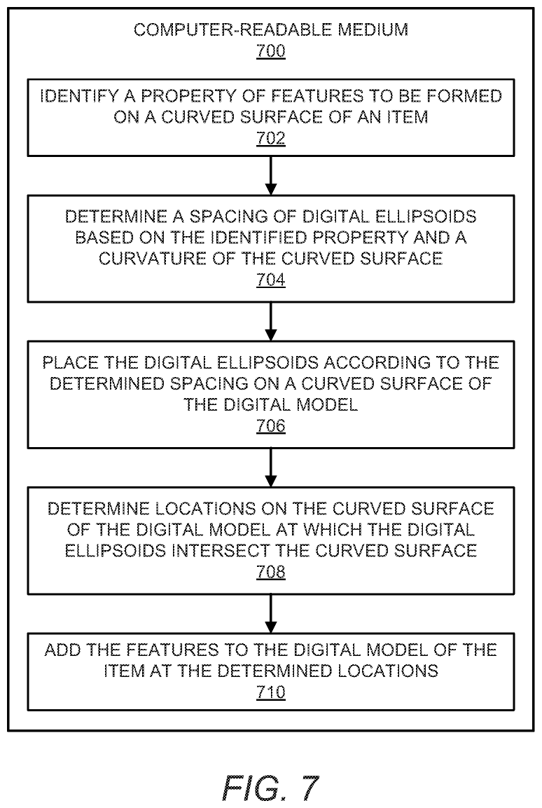

Turning now to FIG. 7, there is shown a block diagram of a computer-readable medium 700 that may have stored thereon computer- readable instructions for determining locations on a surface 302 of a digital model 301 corresponding to points of digital ellipsoids 300 placed to intersect the surface 302. It should be understood that the computer-readable medium 700 depicted in FIG. 7 may include additional instructions and that some of the instructions described herein may be removed and/or modified without departing from the scope of the computer-readable medium 700 disclosed herein. The computer- readable medium 700 may be a non-transitory computer-readable medium, in which the term “non-transitory” does not encompass transitory propagating signals.

The computer-readable medium 700 may have stored thereon machine-readable instructions 702-710 that a processor, such as the processor 102 depicted in FIG. 1, may execute. The computer-readable medium 700 may be an electronic, magnetic, optical, or other physical storage device that contains or stores executable instructions. The computer-readable medium 700 may be, for example, Random Access memory (RAM), an Electrically Erasable Programmable Read-Only Memory (EEPROM), a storage device, an optical disc, and the like.

The processor may fetch, decode, and execute the instructions 702 to identify, on a digital model 301 of an item 200, a property of a plurality of features 202 to be formed on a surface 206 of the item 200. The processor may fetch, decode, and execute the instructions 704 to determine a spacing of a plurality of digital ellipsoids 300 to be placed to intersect a surface 302 of the digital model 301 based on the identified property of the plurality of features and a curvature of the surface 302 of the digital model 301. The processor may fetch, decode, and execute the instructions 706 to place the plurality of digital ellipsoids 300 according to the determined spacing to intersect the surface 302 of the digital model 301. The processor may fetch, decode, and execute the instructions 708 to determine locations 310 on the surface 302 of the digital model 301 at which the digital ellipsoids 300 intersect the surface 302 as points on the curved surface 302 at which digital representations of the plurality of features 202 are to be formed. The processor may fetch, decode, and execute the instructions 710 to add digital representations of the plurality of features 202 to the digital model 301 of the item 200 at the determined locations 310.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An apparatus comprising:
a processor; and
a memory on which is stored machine-readable instructions that are to cause the processor to:
access a digital model of an item to be fabricated to have a plurality of features, the digital model including a surface;
pack a plurality of digital ellipsoids to intersect the surface of the digital model, wherein the plurality of digital ellipsoids are arranged with respect to each other based on a curvature of the surface;
determine locations on the surface at which the plurality of digital ellipsoids intersect the surface; and
set the determined locations as points on the surface at which the plurality of features are to be formed.

2. The apparatus of claim 1, wherein the digital ellipsoids intersect the surface at respective centers of the digital ellipsoids or respective contact positions of the digital ellipsoids to the surface.

3. The apparatus of claim 1, wherein the instructions are further to cause the processor to:
access properties of the features to be formed on the surface; and
determine spacings of the digital ellipsoids that correspond to the features based on the accessed properties of the features to be formed on the surface.

4. The apparatus of claim 3, wherein the instructions are further to cause the processor to access the properties of the features from information corresponding to the digital model, the information comprising a color value and/or a texture value assigned to a surface of the digital model, wherein different color values and/or texture values correspond to different properties.

5. The apparatus of claim 1, wherein the instructions are further to cause the processor to:
add digital representations of the plurality of features at the set points on the surface at which the plurality of features are to be formed.

6. The apparatus of claim 1, wherein the digital model of the item identifies a first area of the surface to be fabricated with the plurality of features arranged with a first property and a second area of the surface to be fabricated with the plurality of features arranged with a second property, and wherein the instructions are further to cause the processor to:
pack the plurality of digital ellipsoids in the first area of the surface of the digital model, wherein centers of the plurality of digital ellipsoids intersect the surface in the first area;
pack a second plurality of digital ellipsoids in the second area of the surface of the digital model, the second plurality of digital ellipsoids being spaced at a different spacing than the plurality of digital ellipsoids, wherein centers of the second plurality of digital ellipsoids intersect the surface in the second area;
determine locations of the first area of the surface corresponding to centers of the plurality of digital ellipsoids;
determine locations of the second area of the surface corresponding to centers of the second plurality of digital ellipsoids; and
set the determined locations of the first area and the second area as points on the surface at which the plurality of features are to be formed.

7. The apparatus of claim 1, wherein the item to be fabricated comprises a screen device for a pulp molding die and the plurality of features comprise pores of the screen device.

8. A method comprising:
accessing, by a processor, a digital model of an item to be fabricated to have a plurality of features;
identifying, by the processor, a property of the plurality of features to be formed on the item;
determining, by the processor, a spacing of a plurality of digital ellipsoids to be placed to intersect a surface of the digital model based on the identified property of the plurality of features;
placing, by the processor, the plurality of digital ellipsoids at the determined spacing on the surface of the digital model, wherein the plurality of digital ellipsoids are placed to intersect the surface; and
determining, by the processor, locations on the surface at which the plurality of digital ellipsoids intersect the surface as points on the surface at which the plurality of features are to be formed.

9. The method of claim 8, wherein the digital model comprises information corresponding to the surface, and wherein identifying the property of the plurality of features comprises identifying the property from the information corresponding to the surface, the information corresponding to the surface comprising a color value and/or a texture value assigned to the surface, wherein different color values and/or texture values correspond to different properties.

10. The method of claim 8, wherein the plurality of digital ellipsoids intersect the surface at respective centers of the digital ellipsoids or respective contact positions of the digital ellipsoids to the surface.

11. The method of claim 8, further comprising:
adding digital representations of the plurality of features at the determined locations on the surface of the digital model.

12. The method of claim 11, further comprising:
causing a three-dimensional (3D) fabrication system to fabricate the item with the plurality of features at the determined locations.

13. The method of claim 8, wherein the digital model of the item identifies a first area of the surface to be fabricated with the plurality of features arranged with a first property and a second area of the surface to be fabricated with the plurality of features arranged with a second property, and wherein the method further comprises:
packing the plurality of digital ellipsoids in the first area of the surface of the digital model, wherein centers of the plurality of digital ellipsoids intersect the surface in the first area;
packing a second plurality of digital ellipsoids in the second area of the surface of the digital model, the second plurality of digital ellipsoids being spaced at a different spacing than the plurality of digital ellipsoids, wherein centers of the second plurality of digital ellipsoids intersect the surface in the second area;
determining locations of the first area of the surface corresponding to centers of the plurality of digital ellipsoids;
determining locations of the second area of the surface corresponding to centers of the second plurality of digital ellipsoids; and
setting the determined locations of the first area and the second area as points on the surface at which the plurality of features are to be formed.

14. A non-transitory computer-readable medium on which is stored machine- readable instructions that when executed by a processor, cause the processor to;
identify, on a digital model of an item, a property of a plurality of features to be formed on a surface of the item;
determine a spacing of a plurality of digital ellipsoids to be placed to intersect a surface of the digital model based on the identified property of the plurality of features and a curvature of the surface of the digital model;
place the plurality of digital ellipsoids according to the determined spacing on the surface of the digital model of the item, wherein the plurality of digital ellipsoids are placed to intersect the surface;
determine locations on the surface of the digital model at which the plurality of digital ellipsoids intersect the surface as points on the surface at which the plurality of features are to be formed; and
add digital representations of the plurality of features to the digital model at the determined locations.

15. The non-transitory computer-readable medium of claim 14, wherein the digital model includes information corresponding to the surface and wherein the instructions are further to cause the processor to:
identify the property of the features are to be formed on the item from the information corresponding to the surface, the information corresponding to the surface comprising a color value and/or a texture value assigned to the surface, wherein different color values and/or texture values correspond to different properties.
